(19) United States
(12) Patent Application Publication
(10) Pub. No.: US 2004/0080542 A1
(43) Pub. Date: Apr. 29, 2004

(54) Database compression and language for cascading choices

(75) Inventors: Randal L. Bertram, Raleigh, NC (US); James C. Cook, Georgetown, KY (US); Patrick E. McCamish, Lexington, KY (US); Gary M. Quesenberry, Clayton, NC (US)

Correspondence Address: THE LAW OFFICE OF IDO TUCHMAN, 69-60 108ST., SUITE 503, FOREST HILLS, NY, 11375, US

(73) Assignee: International Business Machines Corporation

(21) Appl. No.: 10/281,803

(22) Filed: Oct. 28, 2002

(51) Int. Cl. G09G 5/00

(52) U.S. Cl. 345/810; 345/853

(57) ABSTRACT

A method, system, and computer program product for displaying, administrating and modifying client-sided cascading choices containing data levels and data items. The invention includes the operations of associating variables for each data level and each data item and generating visibility rules that define the visibility of each data level and each data item at the client display, wherein the visibility rules include at least some of the associated variables.

### FIELD OF THE INVENTION

The present invention relates generally to computer software, and more specifically to a system for creating, developing and modifying cascading choices for use in network environments.

### BACKGROUND

As the popularity of the Internet grows, many businesses and other entities are shifting away from traditional, static content websites to highly complex and interactive websites. Many modern websites provide users with complex interfaces to help them locate information and resources of interest. These interfaces typically employ combo boxes, toggle buttons, check boxes, and other input mechanisms to receive combinations of selectable data options from users. Selecting the correct combination of data options out of perhaps thousands of selection possibilities, however, can become confusing to users.

One technique known to help users navigate through complex combinations of data choices in an orderly and intelligible manner is known as cascading choices. Cascading choices are often a series of selectable choices that guide the user to a valid data selection. Typically, the choices presented to the user change according to previous selections made. For example, consider a simple user interface having two combo boxes; a State combo box and a City combo box. In the State combo box, the user is prompted to select a particular U.S. state. When the user selects a state, the City combo box changes to list only those cities within the state selected. This type of interface is referred to as cascading choices because a selection in the first combo box (a U.S. state) causes different selection choices to appear in a subsequent combo box (cities of the selected U.S. state). In other words, the user selection cascades down the interface and affects subsequent selection choices.

One technique for providing cascading choices over a network is to configure a client to communicate each new data selection to a server. Once the server receives the data selection, the server transmits a new web page to the client with an updated set of choices in the user interface. For instance, in the example above, when the user specifies a state in the State combo box, the client informs the server which state was selected. The server then responds by providing a new page to the client that limits the City combo box to those cities within the selected state.

Although the above technique is relatively simple to implement over a computer network, it is prone to poor performance. Each time a selection is made, the client must send the selection to the server over the network and the server must reply with a new set of data choices over the network. These operations can take up to several seconds to complete, making the user interface extremely time-consuming and frustrating to use. This drawback is especially noticeable when the user repeatedly traverses up and down the cascading choices before making a final selection. Furthermore, such an interface is highly susceptible to network failures. If the network connection between the client and server is interrupted during the data selection process, the entire interface may become inoperable. Such occurrences can further detract from the overall usability of the cascading choices.

### SUMMERY OF THE INVENTION

The present invention addresses the above-mentioned limitations of the prior art by generating and administrating compact, client-sided programming code for displaying cascading choice that greatly reduces or eliminates client-server communications during the data selection process. Thus, the invention improves the performance and reliability of cascading choices, allowing for a more responsive user interface.

Thus, an aspect of the present invention involves a method for displaying cascading choices at a client display. The cascading choices contain both data levels and data items. The method includes an associating operation that associates variables for each data level and each data item. The method also includes a generating operation that generates visibility rules. The visibility rules define the visibility of each data level and each data item at the client display, and contain at least some of the associated variables.

Another aspect of the invention is a document stored in a computer-readable medium for displaying cascading choices at a client display. The cascading choices contain at least one data level and at least one data item. The document comprises of a data level entry that identifies the data level and includes a data level name. In addition, a data item entry identifies the data item belonging to the data level entry, and contains a data item name. The document further includes at least one visibility rule entry associated with the data level entry or data item entry. The visibility rule entry includes a logical expression defining when the associated entry is made visible. In general, the visibility rule entry is based on the visibility states of other data items and data levels in the cascading choices.

Yet another aspect of the invention is a system for displaying cascading choices at a client computer in a network. As mentioned above, the cascading choices include at least one data level and at least one data item. The system includes a server configured to transmit computer readable code embodied in computer-readable medium to the client over the network. Furthermore, the computer readable code configured to: associate a Boolean variable for each data level and each data item in the cascading choices; instantiate a level object for each data level in the cascading choices; and instantiate an item object for each data item in the cascading choices.

Another aspect of the invention is a computer program product embodied in a tangible media. The computer program product includes computer readable program codes coupled to the tangible media for displaying cascading choices at a client display. The computer readable program codes are configured to cause the program to associate a level variable with each data level and an item variable with each data item. The program codes are also configured to generate a level visibility rule that defines the visibility of the data level at the client display, wherein the level visibility rule includes other associated variables. The program codes are further configured to generate an item visibility rule that defines the visibility of the item level at the client display, wherein the item visibility rule includes other associated variables.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary network environment embodying the present invention.

FIG. 2 shows an inventory database listing for a fictitious merchant.

FIG. 3 shows an exemplary application window incorporating one embodiment of client-sided cascading choices.

FIG. 4 shows the application window after a Music data item is selected in the Product data level.

FIG. 5 shows a flow chart of an exemplary computer readable program contemplated by the present invention.

FIG. 6 shows an exemplary document containing coding language for efficiently changing, developing and updating cascading choices.

### DETAILED DESCRIPTION OF THE INVENTION

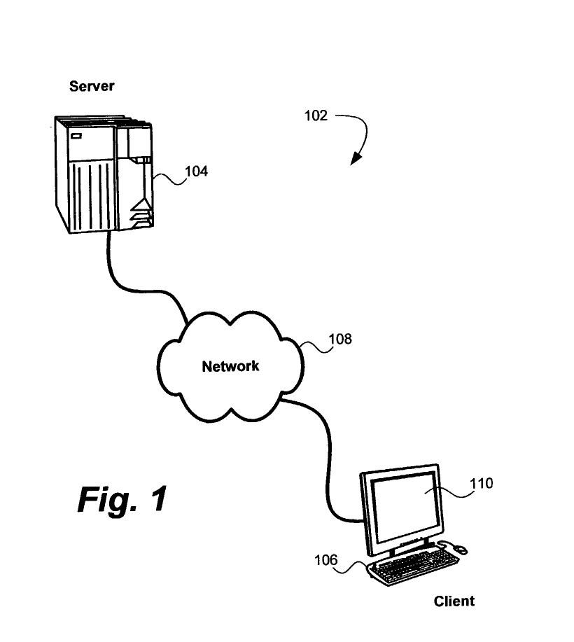

The invention is described herein with reference to FIGS. 1-6. As discussed below, the present invention improves the usability of cascading choices by creating compact client-sided pages containing data levels and selectable data items. The invention greatly reduces, if not eliminates altogether, client-server communications during the data selection process. By reducing client-server communications, the responsiveness to user selections is noticeably improved. Furthermore, reduced client-server communications enhance data selection reliability by reducing failed data transmissions. In addition, the present invention provides a technique for facilitating cascading choice construction and customization.

In FIG. 1, a computing environment 102 embodying the present invention is shown. The environment 102 includes a server 104 and a client 106 in communication via a computer network 108. It is noted that the computing environment 102 shown is one of countless configurations in which the present invention may be utilized. Thus, it should be understood that the invention is not limited to the arrangements shown and described herein. For example, the network 108 may be any type of network known to those skilled in the art for effectuating electronic communication within the environment 102. The network 108 may be a public network, such as the Internet, a wide area network, a local area network, or any combination thereof. In a particular embodiment of the invention, the network 108 is configured to communicate data packets using standard Transmission Control Protocol/Internet Protocol (TPC/IP) or other known protocols.

The client 106 may be any electronic device capable of receiving data from the server 104 via the network 108. By way of example and not a limitation, the client 106 may be a general-purpose computer, a personal digital assistant (PDA), or a cellular phone. As discussed below, the client 106 does not have to maintain a continuous connection to the network 108. The client 106 includes a program (also referred to as an application) to display information on a client display 110. More specifically, the application displays data choices that the user can navigate through to select various data combinations, as described in detail below.

Similarly, the server 104 may be any electronic device or system capable of communicating data to the client 106 via the network 108. For example, the server 104 may be a web server configured to communicate data packets using standard Hyper Text Transfer Protocol (HTTP) or other network protocols known to those skilled in the art.

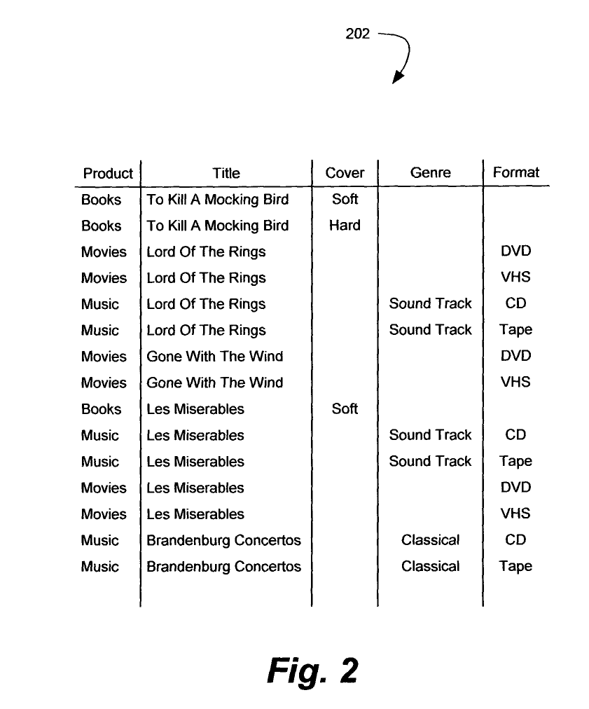

Referring now to FIG. 2, an inventory database listing 202 for a fictitious merchant is shown to help illustrate important concepts of the invention. The merchant, for example, may maintain a website on a web server 104 which customers (clients 106) access through a computer network 108 (see FIG. 1). As shown, the merchant offers an assortment of books, music, and movies for sale. It is contemplated that in real world applications of the invention, the database listing 202 would typically be much larger, perhaps containing thousands of entries. The present invention helps implement such a database listing 202 as client-sided cascading choices.

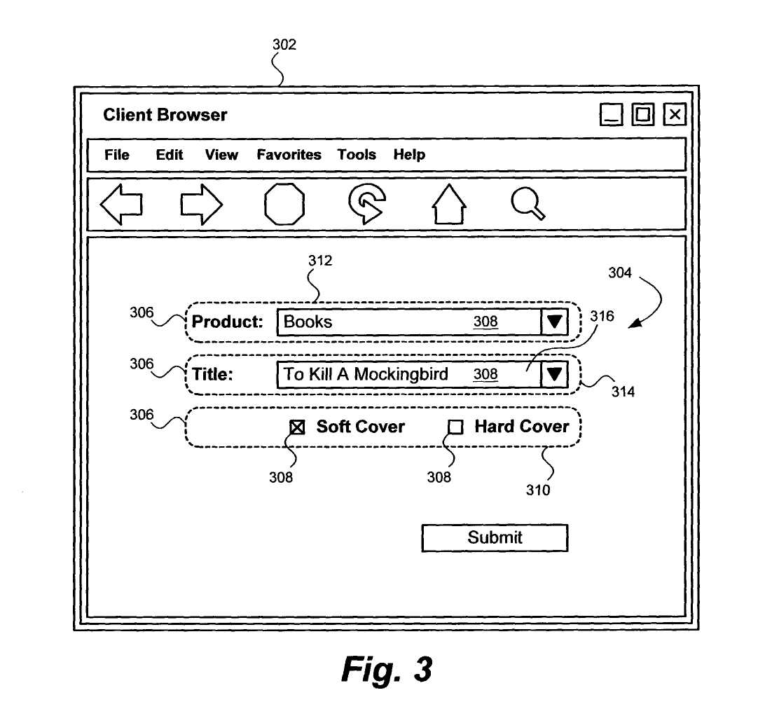

In FIG. 3, an exemplary application window 302 incorporating one embodiment of client-sided cascading choices 304 is shown. In a particular configuration of the invention, the application window 302 is a web browser, such as Netscape Navigator(R) or Microsoft(R) Internet Explorer, and displays information from the server 104. Netscape Navigator is a registered trademark of Netscape Communications Corporation, and Microsoft is a registered trademark of Microsoft Corporation. It is noted that the application window 302 is presented for illustration purposes, and the invention is not limited to the arrangement shown in the figure. For example, the application window 302 can include various text, images, sound, video and other media deliverable to electronic devices from the server.

The application window 302 includes one or more sections of cascading choices 304 where the user is capable of selecting data. Typically, the cascading choices 304 are an electronic form comprising of input buttons, selection boxes, menus, navigation bars and other input metaphors known to those in the art. It is contemplated that the cascading choices 304 can be divided across multiple areas of the application window 302, and even across multiple application windows 302.

Each section of cascading choices 304 includes one or more data levels 306. As used herein, a data level 306 is defined as a portion of the cascading choices 304 where the user is capable of selecting a data choice from a list of possible options. A data level can be any type of control that allows the user to make a selection. For example, a data level can be a drop-down menu, a navigation bar, a group of radio buttons, and so on. Each selectable option within a data level 306 is referred to as a data item 308 belonging to the data level 306. Thus, the Soft/Hard Cover data level 310 has two associated data items: Soft Cover and Hard Cover.

Each data level 306 and each data item 308 can be either visible or invisible to the user. As used herein, a data level or data item is visible when the user has access to it without selecting a new data item. For example, if the Product data level 312 includes a Music data item (not shown but selectable from the drop-down menu), then the Music data item is considered visible. On the other hand, if a data level or data item cannot be viewed without first selecting a new data item, then the data level or data item is considered invisible.

In general, the user logs on the merchant server and selects a desired product in the Product data level 312 (i.e., books, music, or movies). Depending on the product selected, the user is presented with additional choices that narrow down the exact product available for sale. For example, if the user indicates she is looking to purchase a book by selecting the Books data item in the Product data level 312, only book titles are presented in the Title data level 314 to the user for selection. Unlike conventional data selection techniques, the client does not communicate with the server each time more information about the desired product is known. Essentially, the client receives the entire database 202 (see FIG. 2) from the server, thereby allowing client-sided selections to be made without additional network communications with the server.

In one embodiment of the present invention, the cascading choices 304 are implemented at the client using the JavaScript™ scripting language. JavaScript is a trademark of Sun Microsystems, Inc. The JavaScript code defines a data level class and a data item class. The data level class encapsulates a data level 306 and the data item class encapsulates a data item 308. This arrangement offers an advantage typical of object oriented designs: all the items on all the levels share the same code, even if they have different types of controls on the screen. In addition, the visibility of data levels 306 and data items 308 is controlled using the visibility property of layers within the cascading choices 304.

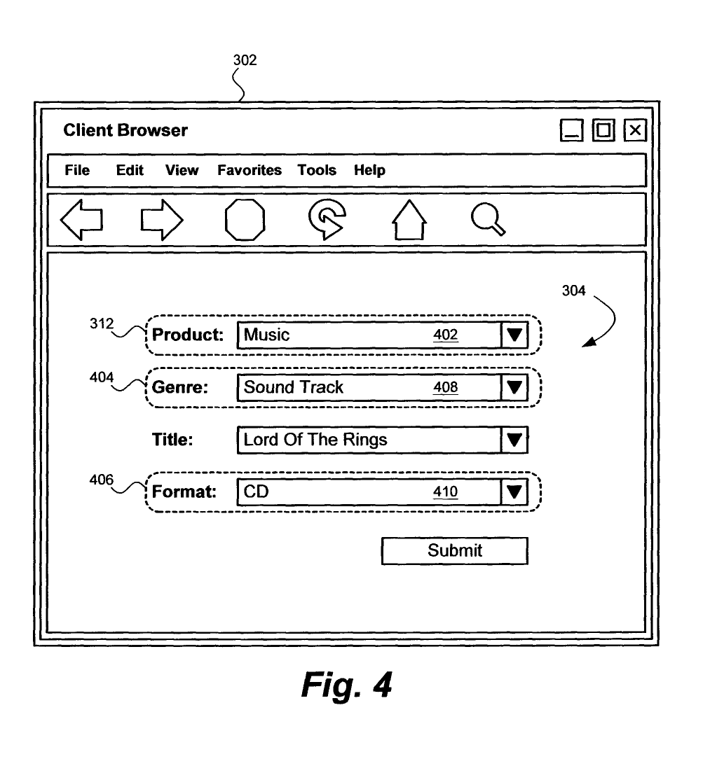

To further illustrate the above concepts, reference is made to FIG. 4, where the application window 302 is shown after the Music data item 402 is selected in the Product data level 312. As a consequence of selecting the Music data item 402, two new data levels are made visible: the Genre data level 404 and the Format data level 406. In addition, the Sound Track data item 408, CD data item 410 and Lord Of The Rings data item 412 are made visible. Moreover, the Soft/Hard Cover data level 310 and the To Kill A Mockingbird data item 316 are made invisible (see FIG. 3) as a result of selecting the Music data item 402.

In accordance with the present invention, the client receives all possible data levels and all possible data items from the server at one time, whether they are immediately visible to the user or not. In addition, each data level and each data item is associated with visibility rules. The visibility rules are received from the server and control when a particular data level or data item is visible to the user. Thus, as the user navigates through the cascading choices and selects data items, the application changes the visibility of various data levels and data items according to the visibility rules.

Because all data levels and all data items are delivered to the client at once, the user enjoys a faster response time when she selects a data item. The invention is particularly beneficial in interfaces where the user is expected to repeatedly traverse the cascading choices up and down before making a final data selection. Furthermore, since there is little or no network communication between the client and server once the data levels and items are delivered to the client, the present invention helps reduce communication errors, such as lost packets and corrupted data, while the user navigates the cascading choices. In addition, the present invention beneficially reduces server load by transferring visibility calculations to the client. Because the client performs visibility computations rather than the server, the server can use its resources for other purposes.

As mentioned above, the client does not have to maintain a network connection with the server while data selection at the cascading choices section is performed. Thus, the client may download a large amount of database entries from the server and then disconnect from the network while the user navigates through the cascading choices. If additional server action is necessary after a data selection is made, the client can reconnect to the server and submit the data choice selection. The ability to disconnect from the network while data selection is performed may be especially useful for portable devices that typically utilize wireless communication technologies. Such technologies may not always be available when the user makes data selections in the cascading choices. The present invention allows the user make data selections even when no network connection exists.

In a particular embodiment of the invention, one or more databases are translated into a client scripting language via the following operations:

1. create a list of all data levels and all data items in the application database;

2. for each data item and data level, create a Boolean variable with a short variable name, e.g., S0-Sz, S10-S1z; and

3. for each data level and data item, create a rule that determines its visibility. The visibility rule is written in the client's scripting language (e.g. JavaScript) using the variables from step 2.

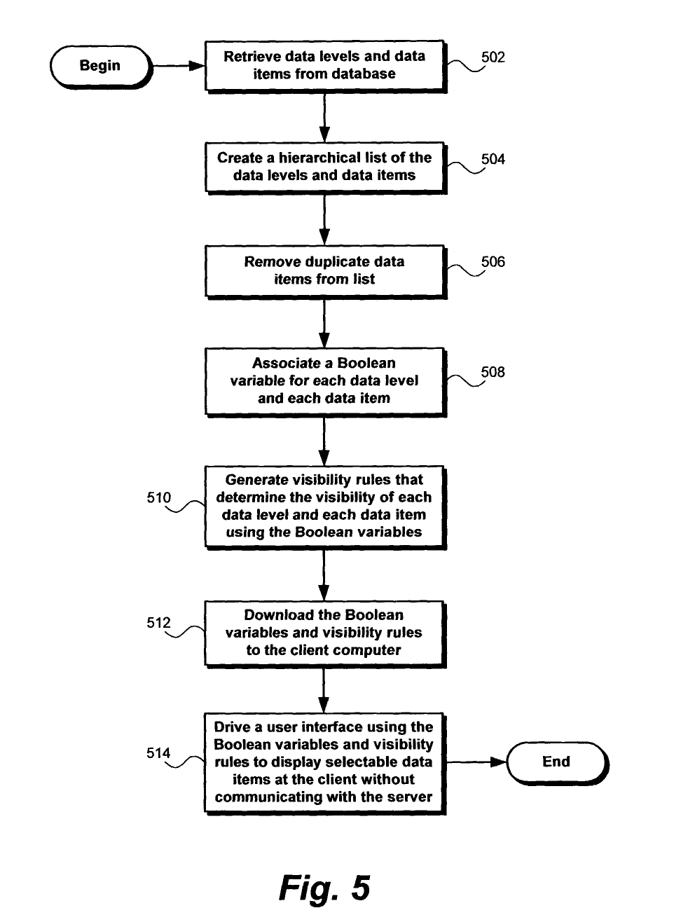

In FIG. 5, a flow chart of an exemplary computer readable program contemplated by the present invention is shown. In accordance with the invention, the operations performed by the computer readable program are embodied as computer readable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Program flow begins with retrieving operation 502. During this operation, the program accesses a database or other data listing and retrieves data levels and data items accessible to the user. It is contemplated that the data levels and data items retrieved may be a subset of the total data levels and data items available in the database. For example, if the client has permission to view only a subset of allowable data items, the server retrieves only those allowable data items. Once the data levels and data items are retrieved, control flow passes to creating operation 504.

At creating operation 504, the retrieved data levels and data items are ordered in a hierarchal listing. This listing defines the cascading behavior of data levels and data items presented to the user. Rank in the hierarchal listing is dependent on how a particular data level affects other data levels. In general, user selections made in a data level higher in hierarchal rank can affect the visibility of data levels and data items of lower hierarchal rank, but selections made in a data level lower in hierarchy cannot affect the visibility of data levels and data items higher in the hierarchy. Data items share the same hierarchal rank as the data level they belong to. For example, and referring back to FIG. 4, the Product data level 312 and its data items 402 are higher in hierarchy than the Genre data level 404 and its data items 408.

In one embodiment of the invention, the hierarchal listing is automatically generated using the structure of the underlying database. It is contemplated that in other embodiments of the invention a designer can reorder the hierarchy of the cascading choices. In such embodiments, a user-interface can be configured to allow the designer to move data levels up or down the hierarchy of the cascading choices. Since changing a data level's hierarchal rank can affect the visibility of various data levels and data items, the interface may additionally be configured to give feedback to the designer by showing the resulting visibility of data items and data levels as the hierarchies are modified. In a further embodiment of the invention, the interface may be configured to enforce the convention that each level can only be affected by the levels above it in the hierarchy. To avoid violating this convention, the system can automatically give a warning to the designer when a level is moved above a level it is dependent on.

Returning to FIG. 5, after the hierarchal listing is generated, control passes to removing operation 506. During the removing operation 506, all duplicate data item entries are deleted from the hierarchal listing. For example, in FIG. 2, all occurrences of the data items “Les Miserables” are consolidated into a single Les Miserables data item. This operation eliminates redundant selection options from the cascading choices, saving client memory usage and download time in situations where data levels have many duplicate data items. Returning once again to FIG. 5, after the removing operation 506 is completed control passes to associating operation 508.

At associating operation 508, Boolean variables are declared and associated with each data level and data item in the hierarchal listing. The Boolean variables are used to indicate whether a particular data level is visible or a particular data item has been selected. For example, if a Boolean variable is “true” or non-zero, then the user has selected the data item it is associated with. The Boolean variables are also used to construct visibility rules for the cascading choices, as described below.

It is contemplated that the Boolean variable names can be automatically generated by referring to the hierarchal listing. In addition, since the number of data items and data levels in the cascading choices can be rather large, short character strings are used for the Boolean variable names. For example, each Boolean variable may begin with the letter S, followed by a base-36 number. Thus, the variable names would be formatted as follows: S0, S1, S2, S3, S4, S5, S6, S7, S8, S9, Sa, Sb, Sc, Sd, Se, Sf, Sg, Sh, Si, Sj, Sk, Sl, Sm, Sn, So, Sp, Sq, Sr, Ss, St, Su, Sv, Sw, Sx, Sy, Sz, S10, and so on. By minimizing the character length of the variable names, the amount time needed to transmit the application information to the client can be substantially reduced. After the associating operation 508 is completed, control passes to generating operation 510.

At generating operation 510, visibility rules are generated according to the database listing. The database is examined to determine under what conditions each data level and each data item should be visible in the cascading choices, and visibility rules are then constructed to express these conditions. Furthermore, the visibility conditions are expressed using the Boolean S-variables. For example, consider the visibility rule:

Level.Genre.rule=S3;

Assuming that the Music data item 402 is associated with Boolean variable S3, this rule indicates that the Genre data level 404 is only visible when the Music data item 402 is selected (see FIG. 4). The visibility rules may include constants, such as “true” or “false”, and logical operators, such as OR (||), AND (&&), and NOT (!). Thus, if it is further assumed that Boolean variable S2 is associated with a Movies data item, then the rule:

Level.Format.rule=S21||S3;

indicates that the Format data level 406 is visible when either the Movies data item or the Music data item 402 is selected. Visibility rules for data items are expressed in a similar manner as rules for data levels, i.e., Item.Cover.Hard.rule=!Sb.

It is important that the visibility rules be expressions in the client's scripting language. Moreover, these expressions should be as concise as possible and be evaluated quickly since every change in one level requires all the visibility rules to be evaluated in all subsequent levels. The speedy evaluation of rules determines the performance of the cascading choices.

In a particular embodiment of the invention, each visibility rule for a data item or data level contains only those variables associated with data items or data levels higher in the hierarchal listing. This requirement ensures that the cascading choices respond to user selections in only one directional flow. In other words, the requirement ensures that visibility changes only travel down the cascading choices, and not up. In a further embodiment of the invention, when a data level has no visible data items (e.g., an empty data level) it becomes invisible, even if its visibility rule does not explicitly make it invisible.

In some cases, typically when there are too many data levels or data items, the cascading choices performance can be unacceptably slow as top level data items are changed. One solution contemplated by the invention is to include a “Continue” button in the application window. The top levels do not ripple down to the lower levels until the Continue button is pressed. Such a configuration solves the performance problem because all the visibility rules in all the levels do not have to be evaluated at once when the user changes a top-level data item.

Returning to FIG. 5, once generating operation 510 is completed, control passes to downloading operation 512. During downloading operation 512, the server sends code to the client to construct the data levels and data items, as well as the visibility rules and Boolean variables. It is contemplated that the information downloaded to the client is encoded in any format know in the art. In one embodiment of the invention, the information is formatted in Dynamic Hypertext Markup Language (DHTML) recognized by most modern Internet browser applications. After the downloading operation 512 is completed, control passes to displaying operation 514.

At displaying operation 514, the client displays the cascading choices using data level objects and data item objects. According to one embodiment of the invention, the data levels and data objects are represented as objects with properties for their associated Boolean variable, visibility rule, and text display. For example, the data level object for the Genre data level may be initialized as follows:

Genre = new Level (“S4”, “Genre”, “S3”,

new Array (

new Item (“S5”, “Classical”, “S4”),
new Item (“S6”, “Sound Track”,“S4”)
)

);

where “S4” is the Boolean variable associated with the Genre data object, “Genre” is the text display for the data level, and “S3” is the visibility rule for the Genre data level. Each data level object also contains an array of data item objects representing the data items belonging to the data level. In the example above, the Genre data level includes an array of two data item objects: one having an associated Boolean variable “S5”, and the other having an associated Boolean variable “S6”.

Every time the user changes one of the data levels, the corresponding data level object is notified. It changes its own data item selection, and then calls the next data level object. From then on, each data level object:

1. Evaluates its own visibility rule, making itself visible or invisible;

2. If it is visible, evaluates the rule in each of its data item objects, making each item visible or invisible; and

3. Calls the next data level object (unless it is the last one).

In this manner, a data item selection ripples down the cascading choices and causes subsequent data levels and data items to appear or hide on the user display.

The present invention also includes a system and method for quickly customizing the cascading choices for special situations not defined in the original database. For example, suppose a coupon is introduced for a certain music CD and for all books, and the user interface sometimes requires a new data level to indicate a coupon order. What if a few of the books are available in digital format, requiring the Format data level to appear for some book orders? Each of these special cases would require a change in the database schema or a modification in the scripting code. However, changing the database or modifying the scripting code may be a cumbersome way to handle such special cases.

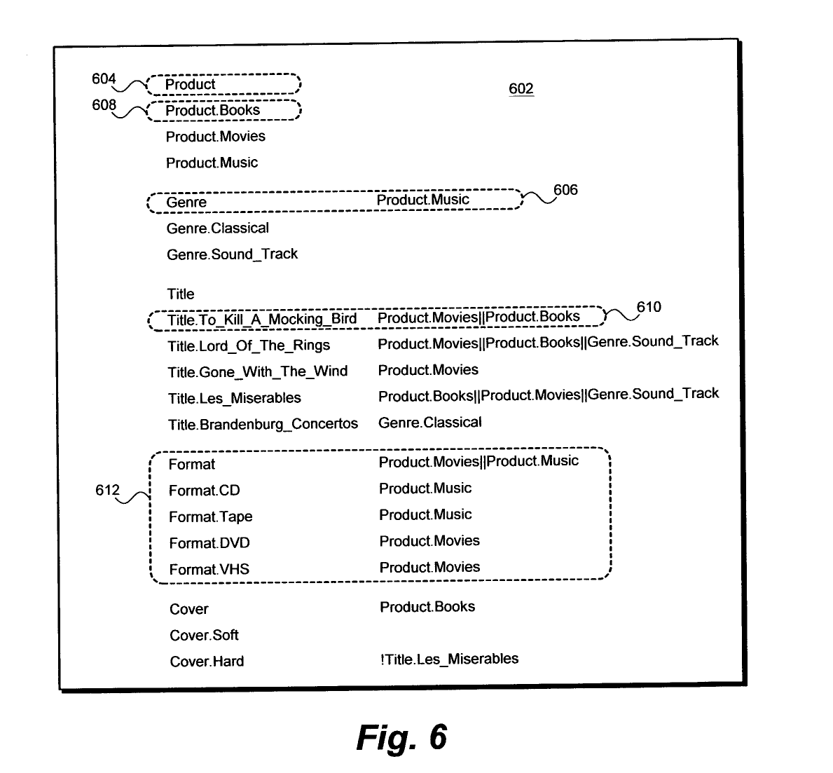

FIG. 6 shows an exemplary document 602 containing coding language for efficiently changing, developing and updating cascading choices. It is noted that coding format shown is just one example of how the language might look; the exact syntax and format may be changed without departing from the scope and spirit of the invention. In general, the language has the following characteristics:

1. each data level is defined;

2. each level's data items are defined as part of the data level; and

3. each data level and data item has a visibility rule determining its visibility.

The coding language includes data level entries 604 identifying data levels within the cascading choices. In one embodiment of the invention, each data level entry 604 has the following format:

level_name [visibility rule]

The level_name is a name assigned to the data level. The visibility rule to the right of the level_name is an optional data level visibility rule associated with the data level entry. If no visibility rule exists then the data level is considered always visible (except if the data level is empty). If a visibility rule is specified, it is a Boolean expression comprising of data level names and data item names defined in the document 602. For example, the Genre data level entry 606 has the rule:

Product.Music

This means that the Genre data level only appears if the Product data level is set to the Music data item.

Each data level entry 604 may be followed by one or more data item entries 608. The data item entries 608 are formatted under the following coding convention:

level_name.item_name [visibility rule]

The item_name is preceded by the level_name of the data level the data item belongs to, and a period separator. The optional visibility rule specifies when the data item should be made visible. If no visibility rule exists for the data item entry 608, then the data item's visibility rule is the same as the visibility rule of the data level it belongs to. As another example, consider the Les_{—}Miserables data item entry 610, which includes the visibility rule:

Product.Books||Product.Movies||Genre.Sound Track

This rule specifies that the Les_{—}Miserables data item appears only if the Product data level is set to Books or Movies, or if the Genre data level is set to Sound Track. The visibility rules can be as complex as needed. They can use any Boolean expression available in the underlying scripting language. For example, the rule for the Les Miserables data item entry 610 could also be coded as:

!Genre.Classical

It is contemplated that level-item sets 612 are formed by grouping all data item entries 608 under the data level entry 604 they belong to. This helps users quickly understand the structure of the cascading choices defined in the document 602. Typically, the document 602 is stored in a computer readable file on the server, where it is complied into data levels and data items as explained above. The compilation process is very straightforward. An S-variable is defined for each data level and data item, and the visibility rules are translated into the corresponding S-variables. The resulting script is downloaded and executed on the client, as detailed above.

In a particular embodiment of the invention, the visibility rules consist of Boolean logic constructs using only previously defined data levels and data items. As discussed above, this restriction ensures that the cascading choices respond to user selections in only one directional flow so that changes in visibility travel down the cascading choices, and not up.

Thus, the present invention includes a coding language for defining data levels and data items. The language gives direct access to data levels, data items, and visibility rules in a human-readable format. The coding language of the present invention helps increase the flexibility of cascading choices. It can easily handle any special case involving data levels and data items. Modifying the language file is quick and simple, especially when compared to modifying a database schema or JavaScript code.

It is contemplated that for large-scale applications involving cascading choices with many data levels and/or data items, developers can take advantage of both direct database translation techniques and the coding language techniques of the present invention. To access the database from the coding language, the user can include macro entries. For example, the entire Title level-item set could be rewritten as:

Title

Title. % list(Title) %

The %list(Title) % macro entry represents all the titles from the database 202 (see FIG. 2), followed by the rule for the title. Data levels and data items created from the database can be modified in the coding language using identical data level or data item names in both documents. Rules generated from the database and the coding language can be OR'ed together. If a coding language rule ends with an AND operation (&&), the coding language rule is AND'ed with its corresponding database rule. This allows the coding language to augment or override the database rules for a particular level or item. Now the cascading choices language is doing what it does best: setting up the data levels and some of the data items, and defining special cases in their behavior. The database is doing what it does best: handling large structures of data.

The foregoing description of the invention has been presented for purposes of illustration and description. It is not intended to be exhaustive or to limit the invention to the precise form disclosed, and other modifications and variations may be possible in light of the above teachings. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for displaying cascading choices at a client display, the cascading choices including data levels and data items, the method comprising:
associating variables for each data level and each data item; and
generating visibility rules that define the visibility of each data level and each data item at the client display, wherein the visibility rules include at least some of the associated variables.

2. The method of claim 1, further comprising:
for each data level, instantiating a level object, the level object including an indicia of the variable associated with the data level and an indicia of the visibility rule determining the visibility of the data level; and
for each data item, instantiating an item object, the item object including an indicia of the variable associated with the data item and an indicia of the visibility rule determining the visibility of the data item.

3. The method of claim 1, wherein associating variables further comprises minimizing names for the variables.

4. The method of claim 1, further comprising creating a hierarchical list of the data levels and data items, wherein the visibility rule for each data level and each data item includes only variables for data levels and data items higher in hierarchical list.

5. The method of claim 1, further comprising downloading the variables and visibility rules to the client computer.

6. In a computer-readable medium having stored thereon a document for displaying cascading choices at a client display, the cascading choices including at least one data level and at least one data item, the document comprising:
a data level entry identifying the data level, the data level entry including a data level name;
a data item entry identifying the data item belonging to the data level entry, the item entry including a data item name; and
at least one visibility rule entry associated with at least one of the data level entry and the data item entry, the visibility rule entry including a logical expression defining when the associated entry is made visible.

7. The document of claim 6, wherein the data item entry is associated with the data level entry by including the data level name within the data item name.

8. The document of claim 6, wherein the data level entry occupies a separate line in the document, and wherein the visibility rule is associated to the level entry when the visibility rule is on the same line as the data level entry.

9. The document of claim 6, wherein the data item entry occupies a separate line in the data structure, and wherein the visibility rule is associated to the data item entry when the visibility rule is on the same line as the item entry.

10. The document of claim 6, further comprising a macro entry configured to import information external to the document.

11. A system for displaying cascading choices at a client computer in a network, the cascading choices including at least one data level and at least one data item, the system comprising:
a server configured to transmit computer readable code embodied in computer-readable medium to the client over the network, the computer readable code configured to:
associate a Boolean variable for each data level and each data item in the cascading choices;
instantiate a level object for each data level in the cascading choices; and
instantiate an item object for each data item in the cascading choices.

12. The system of claim 11, wherein the level object comprises:
a variable property including an indicia of the Boolean variable associated with the data level; and
a rule property including an indicia of a visibility rule for determining the visibility of the data level.

13. The system of claim 12, wherein the visibility rule is a logical equation containing Boolean variables associated with data levels and data items.

14. The system of claim 11, wherein the item object comprises:
a variable property including an indicia of the Boolean variable associated with the data item; and
a rule property including an indicia of a visibility rule for determining the visibility of the data item.

15. The system of claim 14, wherein the visibility rule is a logical equation containing Boolean variables associated with data levels and data items.

16. A computer program product embodied in a tangible media comprising:
computer readable program codes coupled to the tangible media for displaying cascading choices at a client display, the cascading choices including at least one data level and at least one data item, the computer readable program codes configured to cause the program to:
associate a level variable with each data level;
associate an item variable with each data item;
generate a level visibility rule that defines the visibility of the data level at the client display, wherein the level visibility rule includes other associated variables; and
generate an item visibility rule that defines the visibility of the item level at the client display, wherein the item visibility rule includes other associated variables.

17. The computer program product of claim 16, wherein the computer readable program codes are further configured to cause the program to:
instantiate a level object for the data level, the level object including an indicia of the level variable and an indicia of the level visibility rule; and
instantiate an item object for the data item, the item object including an indicia of the item variable and an indicia of the item visibility rule.

18. The computer program product of claim 16, wherein the computer readable program codes are further configured to cause the program to minimize names for the level variable and the data variable.
